(19) United States
(12) Patent Application Publication
(10) Pub. No.: US 2020/0166107 A1
(43) Pub. Date: May 28, 2020

(54) Planetary Screw And Machine Tool Including Same

(71) Applicant: CHUAN HONG PRECISION TOOL MANUFACTURING CO., LTD., Kaohsiung (TW)

(72) Inventor: San-Kuei Wu, Kaohsiung (TW)

(21) Appl. No.: 16/212,764

(22) Filed: Dec. 7, 2018

(30) Foreign Application Priority Data
Nov. 26, 2018 (CN) 201811417138.6

(51) Int. Cl. F16H 25/22; F16H 25/24

(52) U.S. Cl. CPC F16H 25/2252; F16H 25/2418

(57) ABSTRACT

A planetary screw includes a main screw having an outer threading and a connecting portion. A nut includes a hole extending through two end faces of the nut. The hole includes an inner periphery having an inner threading. A planetary unit includes a supporting mechanism and a plurality of rollers rotatably supported by the supporting mechanism to rotate in a fixed position. The plurality of rollers is identical to each other. Each of the plurality of rollers has an outer threading meshed with the outer threading of the main screw and the inner threading of the nut. The planetary screw can be used in a machine tool.

### CROSS REFERENCE TO RELATED APPLICATIONS

The application claims the benefit of China application serial No. 201811417138.6, filed on Nov. 26, 2018, the subject matter of which is incorporated herein by reference.

### BACKGROUND OF THE INVENTION

### 1. Field of the Invention

The present invention relates to a linear translational mechanism and a machine tool including the linear translational mechanism and, more particularly, to a planetary screw for converting a rotational motion into a linear translational motion or vice versa, and a machine tool including the planetary screw.

### 2. Description of the Related Art

With reference to FIG. 1, a conventional planetary screw 9 includes a main screw 91, a nut 92, and a plurality of rollers 93 mounted between the main screw 91 and the nut 92. The main screw 91 includes an outer threading 911. The nut 92 includes an inner threading 921 and two non-threaded portions 922 on two sides of the inner threading 921. Each non-threaded portion 922 receives a shaft ring 94. Each shaft ring 94 includes an inner annular toothed portion 941 and receives a fixing board 95. The plurality of rollers 93 is identical to each other. Each of the plurality of rollers 93 includes an outer threading 931 and an outer toothed portion 932. Two ends of each of the plurality of rollers 93 extend through the fixing boards 95. The plurality of rollers 93 is disposed around the main screw 91 at regular angular intervals and is coaxial to the main screw 91. The outer threading 931 of each of the plurality of rollers 93 meshes with the inner threading 921 of the nut 92 and the outer threading 911 of the main screw 91. The outer toothed portion 932 of each of the plurality of rollers 93 meshes with the inner annular toothed portion 941 of an associated one of the shaft rings 94. Thus, the nut 92 can move axially relative to the main screw 91, or the main screw 91 can move axially relative to the nut 92.

To maintain smooth rotation of the planetary screw 9, an oil seal 951 is mounted between each of the two fixing boards 95 and an associated one of the shaft rings 94, and lubricating oil is filled into the nut 92 and between the two fixing boards 95. Furthermore, two end caps 96 are threadedly coupled to the main screw 91 to seal two ends of the nut 92, preventing leakage of the lubricating oil.

In the conventional planetary screw 9, to assure stable rotation of the plurality of rollers 93 about the main screw 91 and in the nut 92, the plurality of rollers 93 must be processed to form the outer toothed portion 932, the nut 92 must be processed to form the two non-threaded portions 922 that receive the shaft rings 94, and the shaft rings 94 must be processed to form the inner annular toothed portions 941. As a result, the conventional planetary screw 9 has a complicated structure and results in an increase in the processing costs.

Furthermore, the lubricating oil still tends to gradually leak through portions at the outer threading 911 of the main screw 91 and the outer threadings 931 of the plurality of rollers 93, such that noise occurs when the planetary screw rotates. Thus, the two end caps 96, the two fixing boards 95, the shaft rings 94 and the plurality of rollers 93 must be frequently and troublesomely detached before filling the lubricating oil into the nut 92 and between the two fixing boards 95. As a result, the filling of the lubricating oil is troublesome and difficult.

Thus, improvement to the conventional planetary screw is desired.

### SUMMARY OF THE INVENTION

When the terms “front”, “rear”, “left”, “right”, “up”, “down”, “top”; “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

As used herein, the terms “engagement”, “coupling”, “assembly”, or similar terms include two members that can be separated after connection without destructing the members or that cannot be separated after connection, such as welding or threading connection between elements with threadings, which can be appreciated and selected by one having ordinary skill in the art according to the materials or the assembly demands of the elements to be connected.

As used herein, the term “machine tool” refers to a machine capable of processing with various power transmission and output, including converting a rotational motion into a linear translational motion or vice versa. The machine tool can be, but not limited to, a plastic forming machine, a press machine, a linear actuator, or a 3D printer.

To solve the above problem, an objective of the present invention is to provide a planetary screw having a simplified structure to thereby reduce the processing costs.

Another objective of the present invention is to provide a planetary screw having a simple structure while permitting easy filling of the lubricating oil, reducing the noise while the planetary screw rotates.

A further objective of the present invention is to provide a machine tool including the planetary screw, permitting easy maintenance and easy filling of the lubricating oil, thereby reducing the malfunction rate of the machine tool and reducing the noise during rotation of the planetary screw.

A planetary screw according to the present invention includes a main screw having an outer threading and a connecting portion. A nut includes a hole extending through two end faces of the nut. The hole includes an inner periphery having an inner threading. A planetary unit includes a supporting mechanism and a plurality of rollers rotatably supported by the supporting mechanism to rotate in a fixed position. The plurality of rollers is identical to each other. Each of the plurality of rollers has an outer threading meshed with the outer threading of the main screw and the inner threading of the nut.

Thus, in the planetary screw according to the present invention, the supporting mechanism does not contact the main screw and the nut, and only the outer threadings of the plurality of rollers mesh with the outer threading of the main screw and the inner threading of the nut to enable the plurality of rollers to rotate and revolve relative to the main screw and the nut. The overall structure is simple, and the friction is reduced. Thus, the processing costs of the planetary screw can be significantly reduced, and the production efficiency and assembly efficiency can be enhanced. Since the supporting mechanism does not directly contact the main screw and the nut, the noise resulting from rotation of the planetary screw can be reduced.

In an example, wherein the hole of the nut is a stepped hole. The inner periphery of the hole of the nut includes an intermediate section having a first inner diameter and two end sections respectively on two sides of the intermediate section. Each of the two end sections of the stepped hole includes a second inner diameter larger than the first inner diameter and is a sealing portion. The inner threading is at the intermediate section. This assures that the outer threadings of the plurality of rollers can only mesh with the inner threading of the nut, avoiding the outer threadings of the plurality of rollers from impinging the other portions of the inner periphery of the nut.

In an example, the nut includes at least one through-hole extending from the inner periphery of the nut through an outer periphery of the nut, and a plug is removably received in each of the at least one through-hole. Thus, the lubricating oil can be conveniently filled into the nut.

In an example, the nut includes two through-holes configured to connect to two oil guiding pipes, respectively. Thus, the lubricating oil can be circulatingly filled into the nut.

In an example, the supporting mechanism includes two fixing boards and a plurality of fixing rods. Each of the two fixing boards includes a central hole at a central portion thereof and a plurality of fixing holes surrounding the central hole. The plurality of fixing holes is located on a circumference having the same radius about a central axis of the central hole. Each of the plurality of fixing rods has two ends respectively mounted in the plurality of fixing holes. Thus, the supporting mechanism reliably supports the plurality of rollers to rotate at a fixed position.

In an example, each of two ends of each of the plurality of fixing rods includes an engaging portion protruding beyond an associated one of the two fixing boards. Each engaging portion includes an outer threading configured to be in threading connection with an engaging member. Thus, the plurality of fixing rods can be conveniently detached and assembled, such that the supporting mechanism and the plurality of rollers can be conveniently maintained and replaced.

In an example, each of the plurality of fixing rods has an outer threading. The plurality of fixing rods is identical. The outer threading of each of the plurality of fixing rods meshes with the outer threading of the main screw and the inner threading of the nut. A gap exists between each engaging member and an associated one of the two fixing boards. Each gap is slightly larger than a backlash between the outer threading of each of the plurality of fixing rods and the outer threading of the main screw and another backlash between the outer threading of each of the plurality of fixing rods and the inner threading of the nut. Thus, the plurality of fixing rods can rotate and revolve relative to the main screw and the nut.

In an example, each engaging member is received in an associated one of the plurality of fixing holes. Thus, the engaging members will not protrude beyond the faces of the two fixing boards.

In an example, each engaging member protrudes beyond an outer face of an associated one of the two fixing boards and does not contact the nut. Thus, the engaging members are prevented from impinging the nut, and the plurality of fixing rods can be conveniently detached.

In an example, each of two ends of the plurality of rollers includes a mounting portion rotatably extending through the fixing hole of an associated one of the two fixing boards. Thus, the plurality of rollers can rotate smoothly between the two fixing boards.

In an example, wherein any two adjacent fixing rods of the plurality of fixing rods has the same quantity of rollers therebetween. Thus, the plurality of fixing rods can uniformly withstand the friction resulting from the revolution of the plurality of rollers relative to the main screw and the nut, achieving excellent, balanced load.

In an example, each of the sealing portions at the two end sections of the nut has a sealing member detachably engaged with the nut. The sealing members seal the lubricating oil in the nut to avoid leakage, improving the tidiness of the working environment and preventing ambient dust or alien objects from entering the rotational space, thereby avoiding the rotational smoothness of the nut and the main screw from being adversely affected.

In an example, each sealing member is made of an elastic material. Thus, the sealing members provide a better sealing effect to avoid leakage of the lubricating oil.

In an example, each sealing member is in threading connection with the main screw. Each sealing member includes a threading having a pitch and a shape. The pitch or the shape of each sealing member is different from a pitch or a shape of the outer threading of the main screw. This assures the sealing members to seal the lubricating oil in the hole of the nut, avoiding the lubricating oil from leaking through the threading connection portions between the sealing members and the main screw.

Furthermore, the planetary screw according to the present invention can be used in a machine tool for converting a rotational motion into a linear translational motion or vice versa. Furthermore, maintenance and filling of the lubricating oil can be easily carried out with the planetary screw.

The present invention will become clearer in light of the following detailed description of illustrative embodiments of this invention described in connection with the drawings.

### BRIEF DESCRIPTION OF THE DRAWINGS

FIG. 1 is a diagrammatic cross sectional view of a conventional planetary screw.

FIG. 2 is an exploded, perspective view of a planetary screw of a first embodiment according to the present invention.

FIG. 3 is an exploded, perspective view of a planetary unit of the planetary screw of the first embodiment according to the present invention.

FIG. 4 is a cross sectional view of the planetary screw of the first embodiment according to the present invention.

FIG. 5 is an enlarged view of a circled portion A of FIG. 4.

FIG. 6 is an enlarged view of another circled portion B of FIG. 4.

FIG. 7 is a cross sectional view of a planetary screw of a second embodiment according to the present invention.

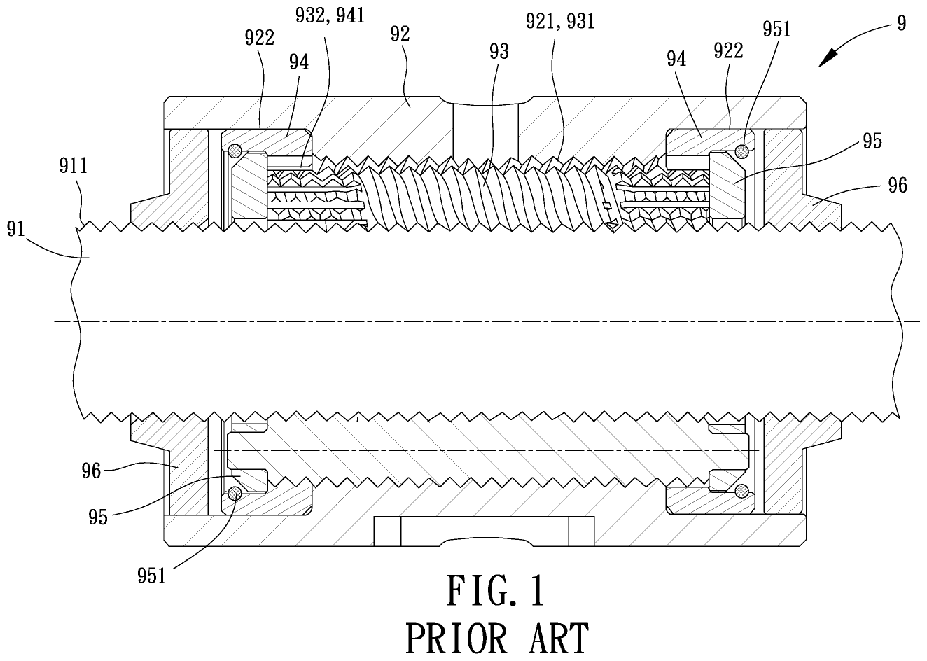

### DETAILED DESCRIPTION OF THE INVENTION

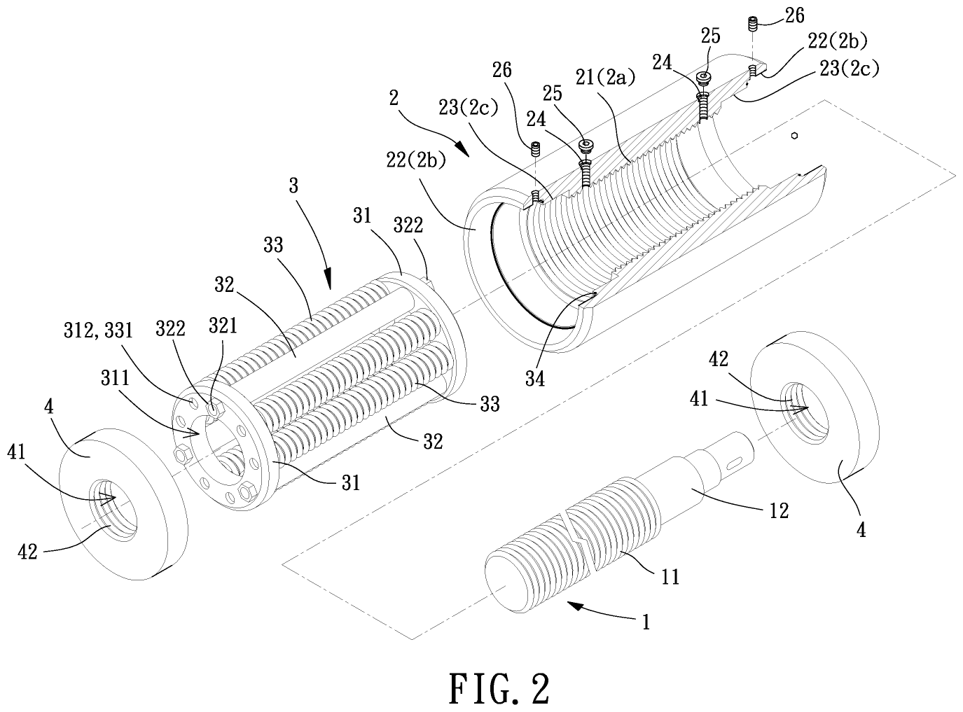

With reference to FIG. 2, a planetary screw of a first embodiment according to the present invention includes a main screw 1, a nut 2, and a planetary unit 3. The planetary unit 3 is disposed in the nut 2 and surrounds the main screw 1, such that the main screw 1 can move axially and linearly relative to the nut 2 and the planetary unit 3 or the nut 2 and the planetary unit 3 can move axially and linearly relative to the main screw 1.

The main screw 1 includes an outer threading 11. The outer threading 11 can be disposed on an end of the main screw 1. The main screw 1 further includes a connecting portion 12 that can be located on the other end of the main screw 1. The connecting portion 12 can be connected to a power device (not shown) for driving the main screw 1 to rotate.

The nut 2 includes a hole extending through two end faces of the nut 2. The hole includes an inner periphery that has a uniform diameter. Alternatively, the inner periphery of the hole can have different diameters to form a stepped hole. In this embodiment, the hole is a stepped hole, and the inner periphery of the stepped hole includes an intermediate section having a first inner diameter 2a and two end sections respectively on two sides of the intermediate section. Each of the two end sections of the stepped hole includes a second inner diameter 2b larger than the first inner diameter 2a. Preferably, a third inner diameter portion is provided between each of the two end sections and the intermediate section and has an third inner diameter 2c larger than the first inner diameter 2a but smaller than the second inner diameter 2b. The intermediate section of the inner periphery of the nut 2 having the first inner diameter 2a has an inner threading 21. Each of the two end sections of the nut 2 having the second inner diameter 2b can be a sealing portion 22. Furthermore, each third inner diameter portion having the third inner diameter 2c can be a recessed portion 23. The nut 2 preferably includes at least one through-hole 24 extending from the inner periphery of the nut 2 through an outer periphery of the nut 2. A plug 25 is removably received in each of the at least one through-hole 24. Thus, lubricating oil can be filled into the nut 2 via the at least one through-hole 24. In a case that the nut 2 is positioned and does not rotate, the nut 2 can include two through-holes 24 configured to connect to two oil guiding pipes (not shown), respectively. Thus, the lubricating oil can circulate through the two through-holes 24, providing a better lubricating effect.

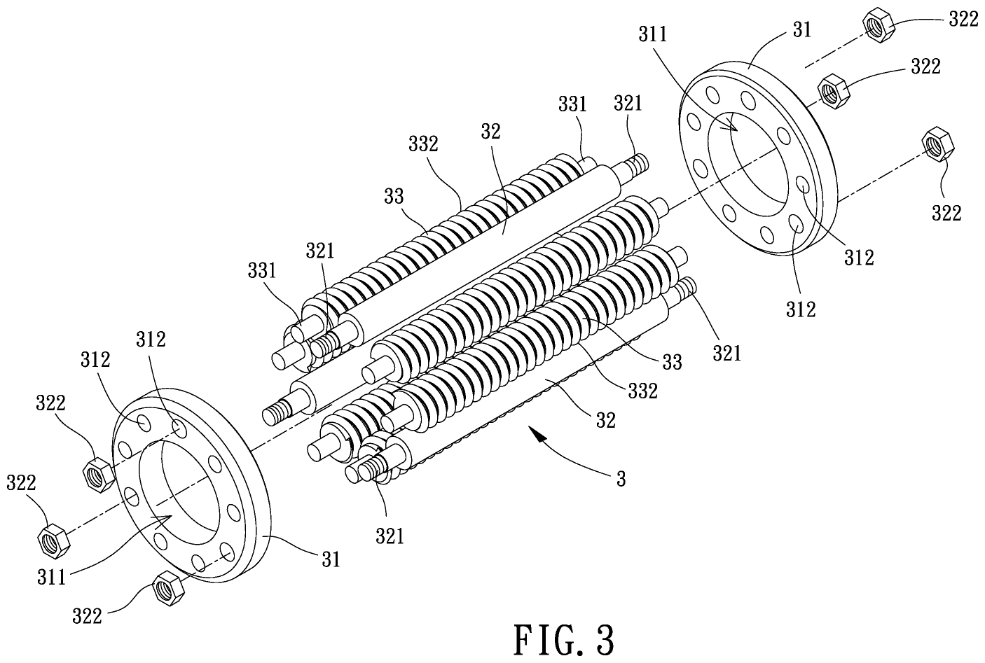

With reference to FIGS. 2-4, the planetary unit 3 includes a supporting mechanism and a plurality of rollers 33 rotatably supported by the supporting mechanism to rotate in a fixed position. In this embodiment, the supporting mechanism includes two fixing boards 31 and a plurality of fixing rods 32 disposed between the two fixing boards 31. Each of the two fixing boards 31 includes a central hole 311 at a central portion thereof. The main screw 1 extends through the central hole 311 of the two fixing boards 31 without contacting inner peripheries of the central hole 311. Each of the two fixing boards 31 further includes a plurality of fixing holes 312 surrounding the associated central hole 311. The plurality of fixing holes 312 is located on a circumference having the same radius and about a central axis of the central hole 311.

Two ends of each of the plurality of fixing rods 32 are respectively engaged in the two fixing boards 31, such that the plurality of fixing rods 32 and the two fixing boards 31 together form a stable supporting mechanism. The plurality of fixing rods 32 surrounds the main screw 1 without contacting the main screw 1 and the nut 2. In this embodiment, each of the two ends of each of the plurality of fixing rods 32 includes an engaging portion 321 protruding beyond an associated one of the two fixing boards 31. Each engaging portion 321 is securely coupled with an engaging member 322. In this embodiment, each engaging portion 321 has an outer threading, and each engaging member 322 is a nut. Each engaging member 322 can be disposed in an associated one of the plurality of the fixing holes 312. Alternatively, each engaging member 322 protrudes beyond an outer face of an associated one of the two fixing boards 31. The two fixing boards 31 and the engaging members 322 correspond to the third inner diameter portions having the third inner diameter 2c of the nut 2 and do not contact with the third inner diameter portions.

Each of two ends of each of the plurality of rollers 33 includes a mounting portion 331 rotatably extending through the fixing hole 312 of an associated one of the two fixing boards 31. The plurality of rollers 33 is identical to each other. Each of the plurality of rollers 33 has an outer threading 332 meshed with the outer threading 11 of the main screw 1 and the inner threading 21 of the nut 2. Thus, the two fixing boards 31 and the plurality of fixing rods 32 of the supporting mechanism do not contact the main screw 1 and the nut 2 while permitting each of the plurality of rollers 33 to revolve and rotate relative to the main screw 1 and the nut 2.

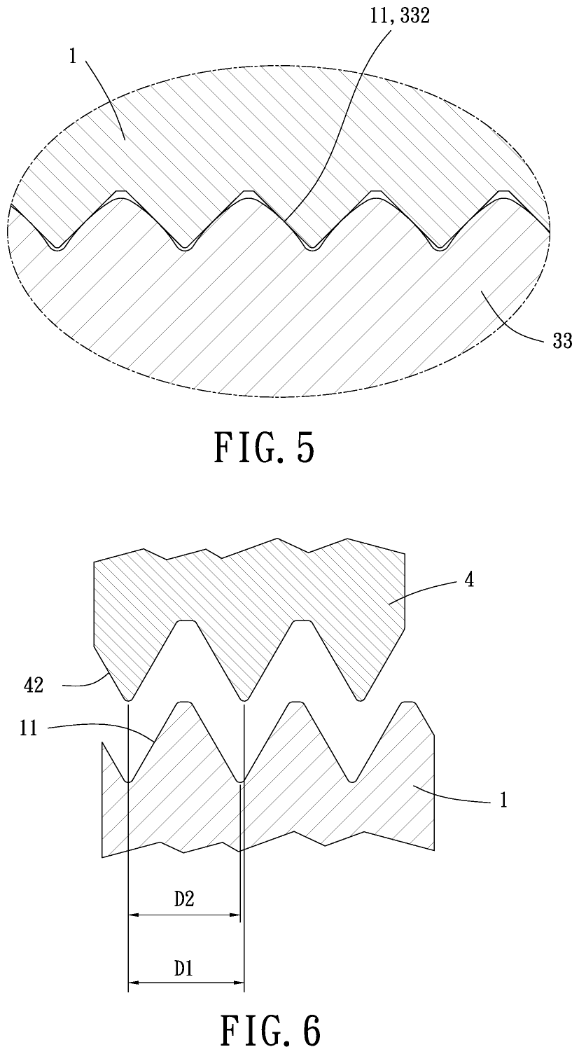

The outer threading 332 of each of the plurality of rollers 33, the outer threading 11 of the main screw 1, and the inner threading 21 of the nut 2 can include a single thread or plural threads. Furthermore, the shape of the outer threading 11 of the main screw 1 is preferably identical to the shape of the inner threading 21 of the nut 2, and the shape of the outer threading 332 of each of the plurality of rollers 33 is preferably different from the shapes of the outer threading 11 of the main screw 1 and the inner threading 21 of the nut 2. As shown in FIG. 5, the outer threading 11 of the main screw 1 and the inner threading 21 of the nut 2 can be mountain-shaped, and the outer threading 332 of each of the plurality of rollers 33 is arcuate. Thus, the contact area between the outer threading 332 of each of the plurality of rollers 33 and the outer threading 11 of the main screw 1 can be reduced to thereby reduce the friction between the outer threadings 11 and 332. Accordingly, noise is reduced, and the rotational smoothness is improved. In alternative embodiments, the outer threading 11 of the main screw 1 and the inner threading 21 of the nut 2 are arcuate, and the outer threading 332 of each of the plurality of rollers 33 is mountain-shaped. The present invention is not limited in this regard.

The central axes of the plurality of rollers 33 and the plurality of fixing rods 32 are on the circumference of the same radius, are disposed around the main screw 1, and are spaced from each other by regular angular intervals. Preferably, a ratio of the number of the plurality of rollers 33 to the number of the plurality of fixing rods 32 is an integer, such that the number of the plurality of rollers 33 between any two adjacent fixing rods 32 is the same. For example, the total number of the plurality of rollers 33 and the plurality of fixing rods 32 is nine, and the ratio of the number of the plurality of rollers 33 to the number of the plurality of fixing rods 32 is 2:1. Thus, the plurality of fixing rods 32 can uniformly withstand the friction resulting from the revolution of the plurality of rollers 33 relative to the main screw 1 and the nut 2, achieving excellent, balanced load.

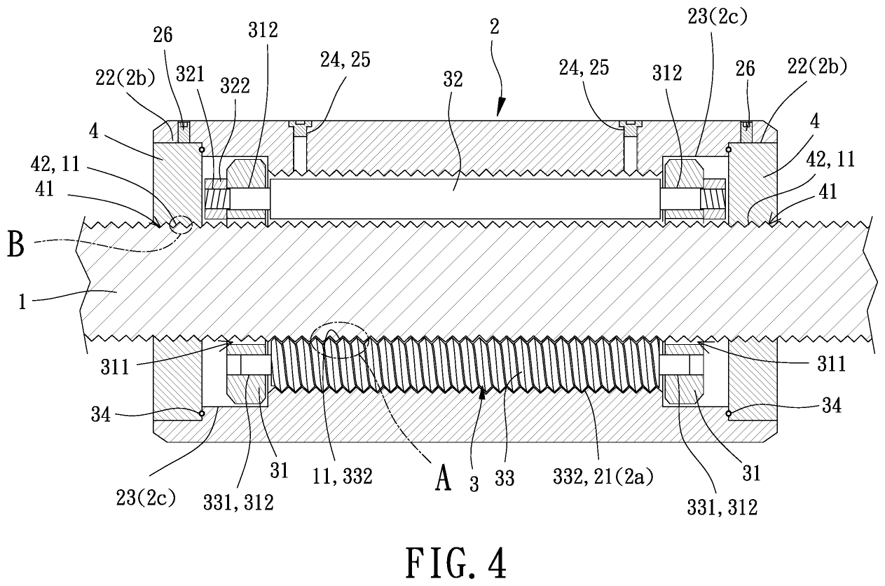

With reference to FIGS. 2 and 4, two sealing members 4 are respectively mounted to two end faces of the nut 2 spaced from each other in the axial direction and are detachably coupled to the sealing portion 22 of the nut 2. The sealing members 4 seal the lubricating oil in the nut 2 to avoid leakage, improving the tidiness of the working environment and preventing ambient dust or alien objects from entering the rotational space, thereby avoiding the rotational smoothness of the nut 2 and the main screw 1 from being adversely affected. In this embodiment, two positioning members 26 extend through the nut 2 to secure the sealing members 4 in place, such that the sealing members 4 and the nut 2 rotate synchronously. Preferably, an anti-leak member 34 is provided between each sealing member 4 and the nut 2 to avoid the lubricating oil from leaking via the engaging portion between the sealing member 4 and the nut 2. Each sealing member 4 includes a through-hole 41 through which the main screw 1 extends. Thus, the main screw 1 extends axially through an interior of the nut 2. The through-hole 41 can include an inner threading 42 threadedly engaged with the outer threading 11 of the main screw 1. The sealing members 4 and the nut 2 jointly move relative to the main screw 1 for use in a machine tool, such as a plastic injection molding machine. The sealing members 4 and the nut 2 can rotate at a fixed position, and the main screw 1 can move linearly relative to the sealing members 4 and the nut 2 to inject plastic material through a nozzle. Alternatively, in other processing machinery, the main screw 1 rotates at a fixed position, and the sealing members 4 and the nut 2 moves axially relative to the sealing members 4 and the nut 2.

With reference to FIG. 6, the sealing members 4 can be made of an elastic material, such as silicone or rubber, such that the inner threading 42 of each sealing member 4 abuts the outer threading 11 of the main screw 1 to prevent leakage of the lubricating oil during rotation of the main screw 1. In an alternative embodiment, the pitch D1 of the inner threading 42 of each sealing member 4 is different from the pitch D2 of the outer threading 11 of the main screw 1. In another alternative embodiment, the shape of the inner threading 42 of each sealing member 4 is different from the shape of the outer threading 11 of the main screw 1. Thus, the inner threading 42 of each sealing member 4 and the outer threading 11 of the main screw 1 can tightly abut each other. Furthermore, the material of the sealing members 4 is elastic to avoid excessive hindrance to the rotation of the main screw 1, enhancing the sealing effect between the sealing members 4 and the main screw 1.

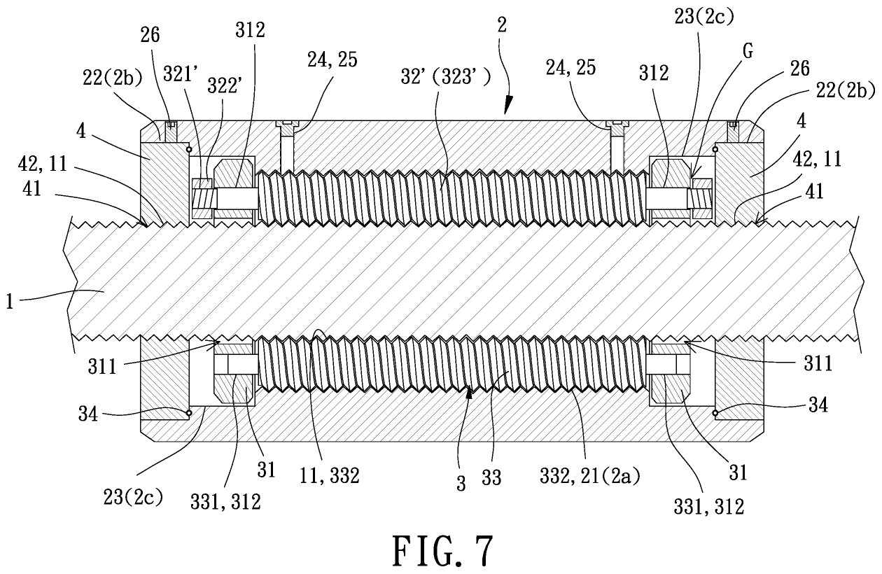

FIG. 7 shows a second embodiment of the main screw 1 according to the present invention. In comparison with the first embodiment, each of the plurality of fixing rods 32′ in this embodiment has an outer threading 323′. The plurality of fixing rods 32′ is identical to each other. Each outer threading 323′ meshes with the outer threading 11 and the inner threading 21 of the nut 2. Two ends of each of the plurality of fixing rods 32′ extend through the two fixing boards 31, such that an engaging portion 321′ on each end of each of the plurality of fixing rods 32′ protrudes beyond an associated one of the two fixing boards 31 and is coupled with an engaging member 322′. Each engaging portion 321′ can be an outer threading, and each engaging member 322′ can be a nut. A gap G exists between each engaging member 322′ and an associated one of the two fixing boards 31. Each gap G is slightly larger than a backlash between the outer threading 323′ of each of the plurality of fixing rods 32′ and the outer threading 11 of the main screw 1 and another backlash between the outer threading 323′ of each of the plurality of fixing rods 32′ and the inner threading 21 of the nut 2. Thus, the plurality of fixing rods 32′ and the two fixing boards 31 form a stable supporting mechanism while permitting the plurality of fixing rods 32′ to slightly move in the axial direction relative to the two fixing boards 31. The engaging members 322′ can be mounted in the fixing holes 312. Alternatively, the engaging members 322′ extend beyond the outer faces of the two fixing boards 31. Furthermore, the two fixing boards 31 and the engaging members 322′ do not contact the third inner diameter portion having the third inner diameter 2c of the nut 2.

By the above structure, when the planetary screw according to the present invention operates, the main screw 1 can be driven to rotate, such that the plurality of rollers 33 meshed with the outer threading 11 of the main screw 1 and the inner threading 21 of the nut 2 can rotate and can revolve about the main screw 1. Thus, when the nut 2 rotates at a fixed position, the main screw 1 can proceed with relative linear motion. Furthermore, when the main screw 1 rotates in the forward direction and the reverse direction, the main screw 1 can proceed with reciprocating linear motion. Alternatively, when the main screw 1 rotates at a fixed position, the sealing members 4 and the nut 2 proceed with relative axial motion, and the sealing members 4 and the nut 2 can proceed with recirpocating linear motion through forward and reverse rotations of the main screw 1.

In view of the foregoing, in the planetary screw according to the present invention, the supporting mechanism does not contact the main screw 1 and the nut 2, and only the outer threadings 332 of the plurality of rollers 33 mesh with the outer threading 11 of the main screw 1 and the inner threading 21 of the nut 2 to enable the plurality of rollers 33 to rotate and revolve relative to the main screw 1 and the nut 2. The overall structure is simple, and the friction is reduced. Thus, the processing costs of the planetary screw can be significantly reduced, and the production efficiency and assembly efficiency can be enhanced. Since the supporting mechanism does not directly contact the main screw 1 and the nut 2, the noise resulting from rotation of the planetary screw can be reduced. Furthermore, the planetary screw according to the present invention can be used in a machine tool to permit convenient maintenance and easy filling of the lubricating oil.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A planetary screw comprising:
a main screw including an outer threading and a connecting portion;
a nut including a hole extending through two end faces of the nut, wherein the hole includes an inner periphery having an inner threading; and
a planetary unit including a supporting mechanism and a plurality of rollers rotatably supported by the supporting mechanism to rotate in a fixed position, wherein the plurality of rollers is identical to each other, wherein each of the plurality of rollers has an outer threading meshed with the outer threading of the main screw and the inner threading of the nut.

2. The planetary screw as claimed in claim 1, wherein the hole of the nut is a stepped hole, wherein the inner periphery of the hole of the nut includes an intermediate section having a first inner diameter and two end sections respectively on two sides of the intermediate section, wherein each of the two end sections of the stepped hole includes a second inner diameter larger than the first inner diameter and is a sealing portion, and wherein the inner threading is at the intermediate section.

3. The planetary screw as claimed in claim 1, wherein the nut includes at least one through-hole extending from the inner periphery of the nut through an outer periphery of the nut, and wherein a plug is removably received in each of the at least one through-hole.

4. The planetary screw as claimed in claim 3, wherein the at least one through-hole includes two through-holes, and wherein the two through-holes are configured to connect to two oil guiding pipes, respectively.

5. The planetary screw as claimed in claim 1, wherein the supporting mechanism includes two fixing boards and a plurality of fixing rods, wherein each of the two fixing boards includes a central hole at a central portion thereof and a plurality of fixing holes surrounding the central hole, wherein the plurality of fixing holes is located on a circumference having a same radius about a central axis of the central hole, and wherein each of the plurality of fixing rods has two ends respectively mounted in the plurality of fixing holes.

6. The planetary screw as claimed in claim 5, wherein each of two ends of each of the plurality of fixing rods includes an engaging portion protruding beyond an associated one of the two fixing boards, wherein each engaging portion includes an outer threading configured to be in threading connection with an engaging member.

7. The planetary screw as claimed in claim 6, wherein each of the plurality of fixing rods has an outer threading, wherein the plurality of fixing rods is identical, wherein the outer threading of each of the plurality of fixing rods meshes with the outer threading of the main screw and the inner threading of the nut, wherein a gap exists between each engaging member and an associated one of the two fixing boards, wherein each gap is slightly larger than a backlash between the outer threading of each of the plurality of fixing rods and the outer threading of the main screw and another backlash between the outer threading of each of the plurality of fixing rods and the inner threading of the nut.

8. The planetary screw as claimed in claim 6, wherein each engaging member is received in an associated one of the plurality of fixing holes.

9. The planetary screw as claimed in claim 6, wherein each engaging member protrudes beyond an outer face of an associated one of the two fixing boards and does not contact the nut.

10. The planetary screw as claimed in claim 5, wherein each of two ends of the plurality of rollers includes a mounting portion rotatably extending through the fixing hole of an associated one of the two fixing boards.

11. The planetary screw as claimed in claim 10, wherein any two adjacent fixing rods of the plurality of fixing rods has a same quantity of rollers therebetween.

12. The planetary screw as claimed in claim 1, wherein each of the sealing portions at the two end sections of the nut has a sealing member detachably engaged with the nut.

13. The planetary screw as claimed in claim 12, wherein each sealing member is made of an elastic material.

14. The planetary screw as claimed in claim 13, wherein each sealing member is in threading connection with the main screw, wherein each sealing member includes a threading having a pitch and a shape, wherein the pitch or the shape of each sealing member is different from a pitch or a shape of the outer threading of the main screw.

15. A machine tool including the planetary screw as claimed in claim 1.
